(19) United States
(12) Patent Application Publication
(10) Pub. No.: US 2011/0102719 A1
(43) Pub. Date: May 5, 2011

(54) HORIZONTAL-ELECTRIC-FIELD LIQUID CRYSTAL DISPLAY APPARATUS

(75) Inventors: Kennosuke Kakehi, Tottori (JP); Kenji Ito, Tottori (JP)

(73) Assignee: Sony Corporation, Tokyo (JP)

(21) Appl. No.: 12/910,555

(22) Filed: Oct. 22, 2010

(30) Foreign Application Priority Data
Oct. 29, 2009 (JP) P2009-248525

(51) Int. Cl. G02F 1/1333

(52) U.S. Cl. 349/122

(57) ABSTRACT

A horizontal-electric-field liquid crystal display apparatus is provided. A pair of substrates are bonded together through a sealing material. A liquid crystal is contained between the pair of substrates. A first electrode and a second electrode are formed on one of the pair of substrates. An electric field generated between the first electrode and the second electrode drives the liquid crystal. A first conductive film composed of a transparent conductive material is formed on a surface of another of the pair of substrates, the surface being opposite a surface in contact with the liquid crystal. The first conductive film is connected to a ground potential through a connection member composed of a conductive material. A second conductive film composed of a transparent conductive material is formed on a surface of the first conductive film. Also, a polarizing plate is formed on a surface of the second conductive film.

### CROSS REFERENCES TO RELATED APPLICATIONS

The present application claims priority to Japanese Patent Application JP 2009-248525 filed on Oct. 29, 2009, the entire contents of which is hereby incorporated by reference.

### BACKGROUND

The present disclosure relates to a horizontal-electric-field liquid crystal display apparatus. Specifically, the present invention relates to a horizontal-electric-field liquid crystal display apparatus in which corrosion of a conductive film that is composed of a conductive material and serves as an electrostatic shield, the corrosion being caused by acid generated from an adhesive agent for a polarizing plate, is suppressed.

A horizontal-electric-field liquid crystal display apparatus has a configuration in which a pair of electrodes are provided so as to be electrically insulated from each other on the inner surface side of one of a pair of substrates provided so as to sandwich a liquid crystal layer, for example, an array substrate between the array substrate and a color filter substrate, and a substantially horizontal electric field is applied to the liquid crystal molecules. As such horizontal-electric-field liquid crystal display apparatuses, there are in-plane switching (IPS) mode apparatuses in which a pair of electrodes do not match with each other in plan view and fringe field switching (FFS) mode apparatuses in which a pair of electrodes match with each other in plan view. Since horizontal-electric-field liquid crystal display apparatuses have an advantage of a wide viewing angle, they have come to be commonly used in recent years.

However, a horizontal-electric-field liquid crystal display apparatus includes a pair of electrodes for driving liquid crystal only on an array substrate and does not include an electrode on a color filter substrate. Accordingly, when an electric field due to static electricity or the like is applied from the color filter substrate side to a horizontal-electric-field liquid crystal display apparatus, this electric field directly affects the liquid crystal molecules and causes abnormal displaying, which is problematic.

Then, to address such a problem, in a horizontal-electric-field liquid crystal display apparatus, a conductive layer or a conductive film that is composed of a transparent conductive material and has a shielding function against static electricity and the like has been provided on a substrate on which a driving electrode is not formed, for example, a color filter substrate.

For example, Japanese Patent No. 2758864 discloses an IPS-mode liquid crystal display apparatus in which a conductive layer is formed on a color filter substrate. Specifically, in the IPS-mode liquid crystal display apparatus disclosed in Japanese Patent No. 2758864, a light-transmissive conductive layer is formed by sputtering at least within a display surface region on a surface of a transparent substrate that is less close to a backlight unit between transparent substrates of a liquid crystal display panel constituting the liquid crystal display apparatus, the surface being opposite a liquid crystal layer. In this IPS-mode liquid crystal display apparatus disclosed in Japanese Patent No. 2758864, the light-transmissive conductive layer has a shielding function against static electricity and the like from the outside and, even when a high potential of static electricity or the like from the outside is applied to the surface of the liquid crystal display panel, the occurrence of abnormal displaying can be prevented.

### SUMMARY

Since the conductive layer having the shielding function is formed in the IPS-mode liquid crystal display apparatus disclosed in Japanese Patent No. 2758864, even when a high potential of static electricity or the like from the outside is applied, the occurrence of abnormal displaying can be prevented, which is highly advantageous. In this case, the invention disclosed in Japanese Patent No. 2758864 describes, as a material for forming the conductive layer, indium tin oxide (ITO), tin oxide (SnO₂), and indium oxide (In₂O₃).

Incidentally, when the thickness of a horizontal-electric-field liquid crystal display panel is decreased, it is difficult to decrease the thickness of a transparent substrate having a conductive film on a surface without damaging the conductive film. Accordingly, the thickness of a transparent substrate is decreased and then the conductive film is formed by sputtering or the like. However, when the conductive film is formed of ITO, since it is extremely difficult to perform a high temperature treatment after the process of decreasing the thickness, a film in an amorphous state is formed. As a result, acid generated from an adhesive agent for a polarizing plate disposed on the surface of the conductive film dissolves the conductive film under high temperature and high humidity, which is problematic. The “amorphous state” is a state in which atoms, molecules, or ions constituting a solid do not have regularity such as a crystalline structure.

To address such dissolution by acid, a light-transmissive conductive material SnO₂ or In₂O₃ may be used as a material for forming the conductive film. However, SnO₂ and In₂O₃ have higher resistance than ITO, which is problematic. When the conductive film has a high resistance, for example, in a system in which a capacitance-type touch panel is mounted on the liquid crystal display apparatus, noise during the operation of the apparatus causes malfunction of the touch panel. Thus, to reduce the influence of operation noise of a liquid crystal display apparatus, a conductive film is made to have a low resistance (which varies in accordance with the wiring configuration of a capacitance-type touch panel; however, the resistance is on the order of several hundreds of ohms) and the conductive film is connected to a ground (GND) potential.

The present embodiments address the above-described existing technical problems by selecting types of transparent conductive materials for forming conductive films and forming a bilayer structure of a low-resistance conductive film and an anti-corrosion conductive film. Thus, the present invention has been accomplished. That is, it is desirable to provide a horizontal-electric-field liquid crystal display apparatus in which corrosion of a conductive film can be suppressed and malfunctions caused by static electricity and the like can be suppressed.

A liquid crystal display panel according to an embodiment is a horizontal-electric-field liquid crystal display apparatus, wherein a pair of substrates are bonded together in peripheral portions of the pair of substrates through a sealing material; a liquid crystal is contained between the pair of substrates; a display region is formed in a portion surrounded by the sealing material and a non-display region is formed outside the display region; a first electrode and a second electrode are formed on one of the pair of substrates; an electric field generated between the first electrode and the second electrode drives the liquid crystal; a first conductive film composed of a transparent conductive material is formed on a surface of another of the pair of substrates, the surface being opposite a surface in contact with the liquid crystal; the first conductive film is connected to a ground (GND) potential through a connection member composed of a conductive material; a second conductive film composed of a transparent conductive material is formed on a surface of the first conductive film; and a polarizing plate is formed on a surface of the second conductive film.

In general, to form a shield electrode, a monolayer film of a transparent conductive film or the like is formed by a sputtering method or the like. However, in a liquid crystal display apparatus according to an embodiment, two conductive films of the first conductive film constituted by a transparent conductive film and the second conductive film constituted by a transparent conductive film are stacked on a surface of the other (for example, a color filter substrate) of the pair of substrates, the surface being opposite a surface in contact with the liquid crystal. As a result, in a liquid crystal display apparatus according to an embodiment, with respect to malfunctions caused by static electricity and the like from the outside of the liquid crystal display apparatus, the first conductive film can discharge static electricity and the like to the GND potential through the connection member connected to the first conductive film; and the second conductive film can suppress dissolution of the first conductive film caused by acid generated from an adhesive agent for the polarizing plate under high temperature and high humidity. Accordingly, a liquid crystal display apparatus that is highly reliable can be provided.

In a liquid crystal display apparatus according to an embodiment, the second conductive film is preferably formed on the surface of the first conductive film except a portion where the first conductive film is in contact with the connection member.

In such a liquid crystal display apparatus according to an embodiment, static electricity and the like in the first conductive film can be efficiently discharged through the connection member directly connected to the first conductive film; and the second conductive film can cover a large area of the first conductive film except a portion where the first conductive film is in contact with the connection member and hence can suppress corrosion of the first conductive film.

In a liquid crystal display apparatus according to an embodiment, in addition to the first conductive film, the second conductive film is also preferably connected to the ground (GND) potential through the connection member.

When a plurality of transparent conductive films are stacked, the resistance between the stacked films is large. In such a liquid crystal display apparatus according to an embodiment, since the second conductive film is directly connected to the GND potential, the resistance between the first conductive film and the second conductive film and the GND potential is small and hence static electricity and the like can be efficiently discharged.

In a liquid crystal display apparatus according to an embodiment, the second conductive film is preferably formed at least in the display region.

In such a liquid crystal display apparatus according to an embodiment, since the second conductive film that is anti-corrosive is formed on the surface of the display region, dissolution of the first conductive film in the display region caused by acid generated from an adhesive agent for a polarizing plate can be suppressed and the occurrence of poor displaying caused by malfunctions due to static electricity and the like can be suppressed.

In a liquid crystal display apparatus according to an embodiment, the first conductive film is preferably formed of ITO.

In such a liquid crystal display apparatus according to an embodiment, since the first conductive film is formed of ITO, which has a low resistance and a high conductivity, noise during the operation of the liquid crystal display apparatus can be further reduced.

In a liquid crystal display apparatus according to an embodiment, the second conductive film is preferably mainly composed of SnO₂ or In₂O₃.

In such a liquid crystal display apparatus according to an embodiment, the second conductive film is mainly composed of SnO₂ or In₂O₃. SnO₂ and In₂O₃ have very high resistances to corrosion, acid, heat, and moisture. Accordingly, the second conductive film is less likely to be dissolved by acid and dissolution of the first conductive film formed under the second conductive film by acid can also be suppressed.

In a liquid crystal display apparatus according to an embodiment, the transparent conductive materials forming the first conductive film and the second conductive film preferably have transmittances close to each other.

In such a liquid crystal display apparatus according to an embodiment, since the transmittances of the first conductive film and the second conductive film are close to each other, refraction of transmitted light between the conductive films is less likely to occur, and poor displaying due to the refraction of transmitted light between the conductive films can be suppressed.

In a liquid crystal display apparatus according to an embodiment, the connection member is preferably formed of a conductive paste.

In such a liquid crystal display apparatus according to an embodiment, by forming the connection member of a conductive paste, electrical connection between the conductive film and the GND potential can be readily established. For example, when a conductive pad is disposed between the conductive film and the GND potential, electrical connections between the conductive film and the conductive pad and between the conductive pad and the GND potential can also be readily established through a conductive paste.

Additional features and advantages are described herein, and will be apparent from the following Detailed Description and the figures.

### BRIEF DESCRIPTION OF THE FIGURES

FIG. 1 is a plan view of a liquid crystal display apparatus according to a first embodiment;

FIG. 2 is an enlarged plan view of a single pixel in a display region illustrated in FIG. 1;

FIG. 3 is an enlarged sectional view taken along line III-III in FIG. 2;

FIG. 4A is an enlarged view of a IVA portion in FIG. 1;

FIG. 4B is a schematic sectional view taken along line IVB-IVB in FIG. 1;

FIG. 5 is a plan view of a liquid crystal display apparatus according to a second embodiment;

FIG. 6A is an enlarged view of a VIA portion in FIG. 5; and

FIG. 6B is a schematic sectional view taken along line VIB-VIB in FIG. 5.

### DETAILED DESCRIPTION

Hereinafter, embodiments will be described in detail with reference to the drawings. Each embodiment below will be described with an FFS-mode liquid crystal display apparatus serving as an example for embodying the technical idea. The present embodiments are not limited to the FFS-mode liquid crystal display apparatuses described herein. In the drawings used for describing the embodiments, in order to make layers and components have recognizable sizes in the drawings, the layers and the components are not drawn to scale and are not necessarily drawn in proportion to the actual sizes.

Although a horizontal-electric-field liquid crystal display apparatus according to an embodiment is applicable to liquid crystal display apparatuses produced by a liquid crystal injection method, the description below will be performed with liquid crystal display apparatuses produced by a one drop fill (hereafter, referred to as “ODF”) method serving as examples. Although liquid crystal display apparatuses are produced with a mother substrate, for convenience of explanation, hereinafter, a single FFS-mode liquid crystal display apparatus serving as a representative example will be described.

### First Embodiment

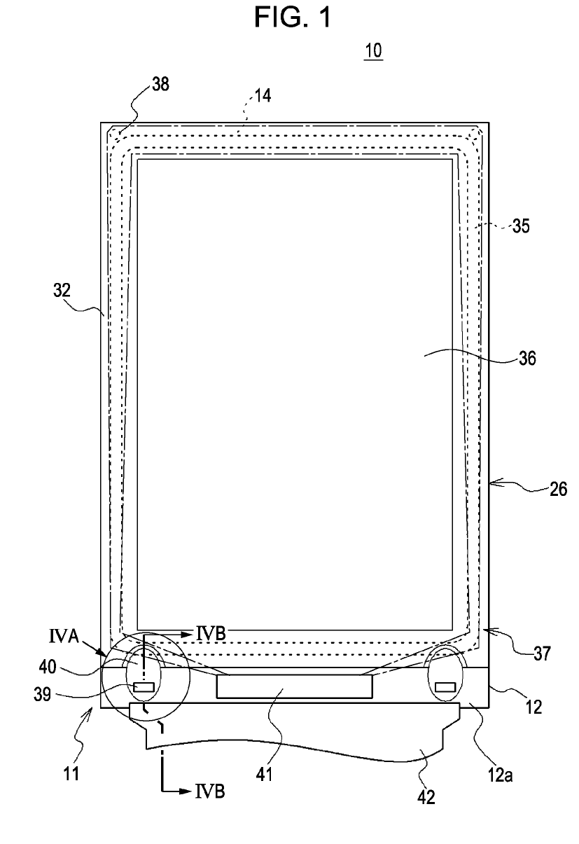

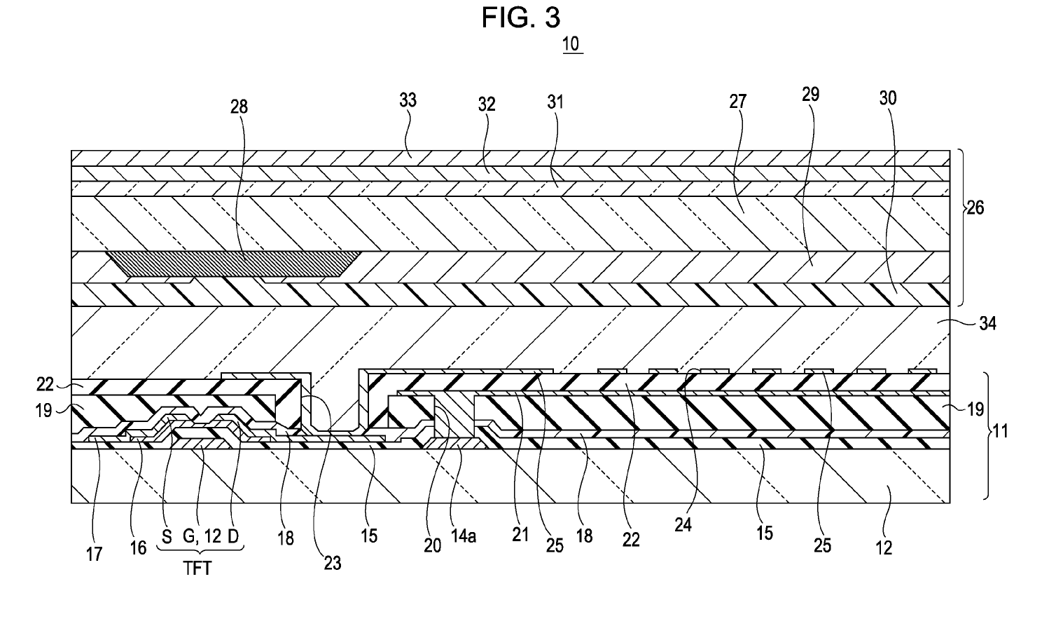

An FFS-mode liquid crystal display apparatus 10 according to a first embodiment will be described with reference to FIGS. 1 to 4B. Referring to FIG. 1, the liquid crystal display apparatus 10 according to the first embodiment is a chip on glass (COG) type liquid crystal display apparatus including an array substrate 11, a color filter substrate 26, a sealing material 35 that bonds the substrates 11 and 26 together, and a liquid crystal 34 (refer to FIG. 3) that is contained in a region surrounded by the array substrate 11, the color filter substrate 26, and the sealing material 35. In the liquid crystal display apparatus 10, a display region 36 is formed in an internal region surrounded by the sealing material 35. A region in which images are not recognized around the display region 36 serves as a non-display region 37 of the liquid crystal display apparatus 10. Since the liquid crystal display apparatus 10 according to the first embodiment is produced by the ODF method, a liquid crystal injection port is not formed.

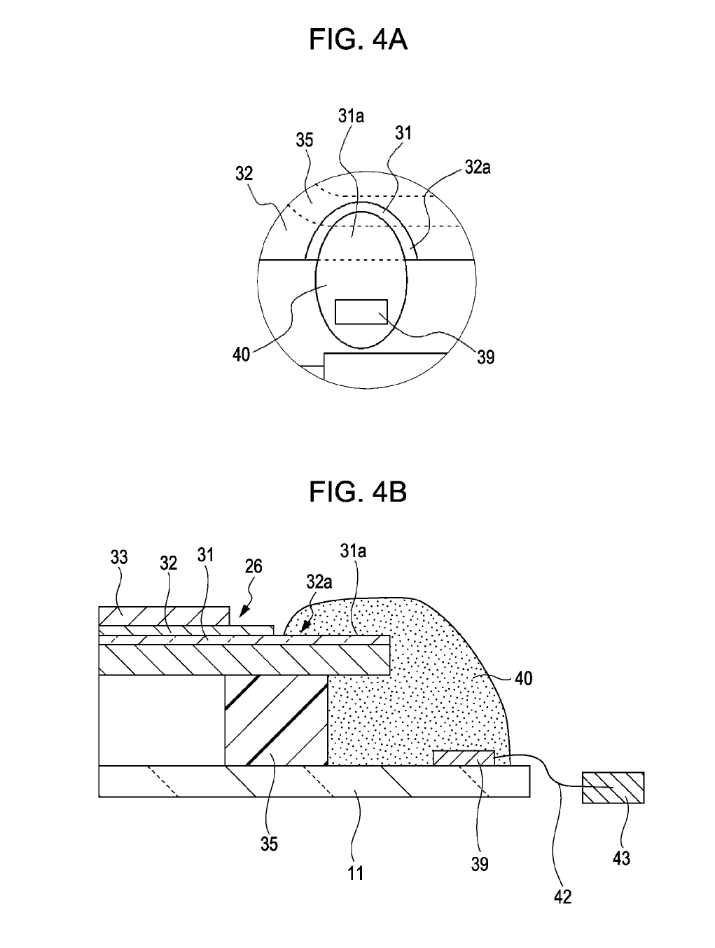

The array substrate 11 is a component in which wires for driving the liquid crystal and the like are formed on a surface of a first transparent substrate 12 that is rectangular and formed of glass or the like. The array substrate 11 is longer in the longitudinal direction than the color filter substrate 26. Thus, when the substrates 11 and 26 are bonded together, an extension portion 12a extending beyond the color filter substrate 26 is formed. A driver IC 41 including an IC chip, LSI, or the like that outputs driving signals, a conductive pad 39, and the like are provided in the extension portion 12a. A common wire 14 extends from the driver IC 41. The conductive pad 39 is electrically connected through an external substrate to a GND potential 43 (refer to FIG. 4B). In the first embodiment, a flexible printed circuit (FPC) 42 is used as an example of the external substrate.

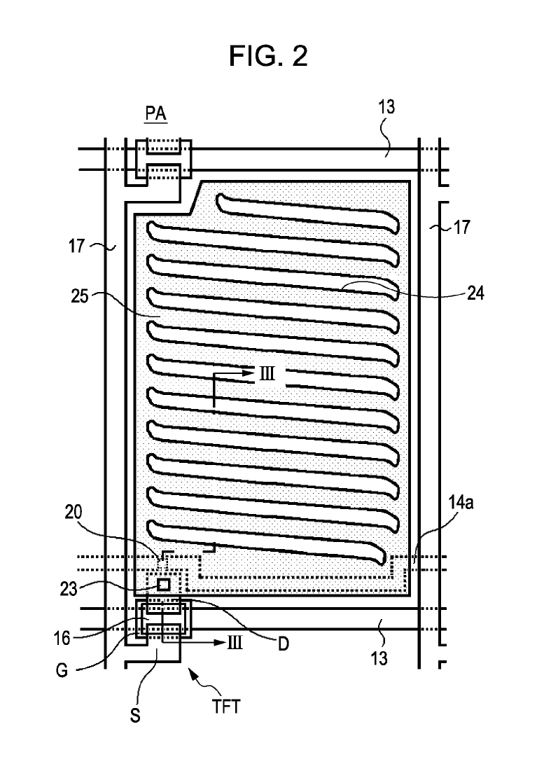

Referring to FIGS. 2 and 3, in the display region 36 of the array substrate 11, a plurality of scanning lines 13 and signal lines 17 and a plurality of common wires 14a that are parallel to the scanning lines 13 and provided between the scanning lines 13 are disposed. A gate insulation film 15 composed of an inorganic insulation material such as silicon oxide or silicon nitride is provided so as to cover the scanning lines 13, the common wires 14a, and the exposed portions of the transparent substrate 12. Thin film transistors (TFTs) that each include a source electrode S, a gate electrode G, a drain electrode D, and a semiconductor layer 16 and serve as switching elements are formed in the vicinity of portions where the scanning lines 13 and the signal lines 17 intersect.

A passivation film 18 composed of an inorganic insulation material such as silicon oxide or silicon nitride is further formed so as to cover these components for the purpose of stabilizing the surface of the components. An interlayer film 19 composed of an organic insulation material is further formed to planarize the surface of the array substrate 11.

Then, first contact holes 20 are formed by a photolithographic technique and en etching technique so as to extend through the gate insulation film 15 and the passivation film 18 to the common wires 14a. This formation of the first contact holes 20 may be performed by a plasma etching technique, which is one of dry etching techniques, or a wet etching technique employing buffered hydrofluoric acid. As a result of the formation of the first contact holes 20, the common wires 14a are exposed.

Then, a transparent conductive layer composed of ITO or IZO (indium zinc oxide) is formed over the entire surface of the first transparent substrate 12 on which the interlayer film 19 has been formed. A lower electrode 21 is formed for each pixel on the surface of the interlayer film 19 by a photolithographic technique and en etching technique. At this time, the lower electrode 21 for each pixel is electrically connected to the common wire 14a through the first contact hole 20. Thus, the lower electrode 21 operates as a common electrode.

Furthermore, an insulation film 22 constituted by a silicon nitride layer or a silicon oxide layer is formed over the entire surface of the first transparent substrate 12 on which the lower electrodes 21 have been formed. At this time, portions of the surface of the interlayer film 19 in which contact holes are to be formed so as to extend to the drain electrodes D are also covered with the insulation film 22. Then, second contact holes 23 are formed by a photolithographic technique and en etching technique in these portions so as to extend through the insulation film 22 and the interlayer film 19 to the drain electrodes D.

Furthermore, a transparent conductive layer composed of ITO or IZO is formed over the entire surface of the first transparent substrate 12 on which the insulation film 22 has been formed. The transparent conductive layer is processed by a photolithographic technique and en etching technique to form, for each pixel, an upper electrode 25 in which a plurality of slits 24 are formed on the surface of the insulation film 22. The upper electrode 25 is electrically connected, in the second contact hole 23, to the drain electrode D of the thin film transistor (TFT) and operates as a pixel electrode. Then, an alignment film (not shown) is provided on the entire surface of the display region 36 including the upper electrodes 25. Thus, the array substrate 11 of the liquid crystal display apparatus 10 according to the first embodiment is provided. A region surrounded by the plurality of scanning lines 13 and signal lines 17 serves as a single sub-pixel region PA. A polarizing plate (not shown) is formed on a surface of the array substrate 11, the surface being opposite a surface in contact with the liquid crystal.

In the color filter substrate 26, a light-shielding film 28 composed of a metal material is formed on a surface of a second transparent substrate 27 composed of glass or the like such that the light-shielding film 28 corresponds to the scanning lines 13, the signal lines 17, and the thin film transistors (TFTs) of the array substrate 11 and covers the non-display region 37.

Furthermore, color filter layers 29 of predetermined colors such as red (R), green (G), and blue (B) are formed on regions surrounded by the light-shielding film 28 on the surface of the second transparent substrate 27. An overcoat layer 30 is formed so as to cover the surfaces of the light-shielding film 28 and the color filter layers 29. The overcoat layer 30 is constituted by a transparent insulation resin film and is provided for the purpose of planarizing the surface of the color filter substrate 26 as much as possible and suppressing diffusion of impurities from the color filter layers 29 into the liquid crystal 34. Then, an alignment film (not shown) is formed on the surface of the overcoat layer 30. Thus, the color filter substrate 26 of the first embodiment is provided.

A conductive film and a polarizing plate are formed on the backside of the transparent substrate 27, that is, a surface opposite a surface in contact with the liquid crystal 34. The detailed configuration of these components will be described below.

Referring to FIG. 1, transfer electrodes 38 that electrically connect the light-shielding film 28 of the color filter substrate 26 and the common wire 14 of the array substrate 11 are formed near two corners on a side opposite the extension portion 12a of the liquid crystal display apparatus 10. As for the above-described array substrate 11 and the color filter substrate 26, for example, the liquid crystal 34 is dropped onto the display region 36 of the array substrate 11; the sealing material 35 composed of an ultraviolet-curable resin or the like is applied to the non-display region 37 of the color filter substrate 26; and the substrates 11 and 26 are bonded together. Then, the sealing material 35 is irradiated with ultraviolet to be cured. Photospacers (not shown) are formed between the color filter substrate 26 and the array substrate 11 for the purpose of maintaining the cell gap between the substrates to be a constant width.

Then, a first conductive film 31 that is composed of ITO, which is a low-resistance transparent conductive material, and operates as an electrostatic shield is formed by sputtering or the like on the back surface of the color filter substrate 26 of the thus-bonded substrates, the back surface being opposite a surface in contact with the liquid crystal 34. Then, a second conductive film 32 composed of SnO₂, which is a corrosion-resistant conductive material, is formed by sputtering or the like on the surface of the first conductive film 31. At this time, referring to FIGS. 4A and 4B, the first conductive film 31 and the second conductive film 32 are formed so as to cover the entire surface of the color filter substrate 26; and, in the second conductive film 32, a cutout portion 32a is formed so as to correspond to the position where a conductive paste 40 is to be applied to the surface of the first conductive film 31.

Then, a polarizing plate 33 is bonded onto the surface of the second conductive film 32 through an adhesive agent. The driver IC 41, the conductive pad 39, and the like are provided on the extension portion 12a of the array substrate 11. A connection portion 31a of the first conductive film 31, the connection portion 31a being exposed through the cutout portion 32a of the second conductive film 32 of the color filter substrate 26, is connected to the conductive pad 39 through the conductive paste 40 composed of a conductive material. Thus, the production of the liquid crystal display apparatus 10 according to the first embodiment is complete. For reference, in FIG. 4B, the FPC 42 connected to the conductive pad 39 and the GND potential 43 connected to the FPC 42 are illustrated.

By employing such a configuration, in the liquid crystal display apparatus according to the first embodiment, with respect to malfunctions caused by static electricity and the like from the outside of the liquid crystal display apparatus, the first conductive film can efficiently discharge static electricity and the like to the GND potential through the conductive paste directly connected to the first conductive film; and the second conductive film that is anti-corrosive can suppress dissolution of the first conductive film caused by acid generated from an adhesive agent for the polarizing plate under high temperature and high humidity. Furthermore, the second conductive film can cover a large area of the first conductive film other than a portion being in contact with the conductive paste to thereby suppress corrosion of the first conductive film. Accordingly, a liquid crystal display apparatus that is highly reliable can be provided.

Since ITO used for the first conductive film of the liquid crystal display apparatus according to the first embodiment has a low resistance and an excellent conductivity, noise during the operation of the liquid crystal display apparatus can be reduced. Since SnO₂ used for the second conductive film of the liquid crystal display apparatus according to the first embodiment has very high resistances to corrosion, acid, heat, and moisture, the second conductive film is less likely to be dissolved by acid and the dissolution of the first conductive film formed under the second conductive film caused by acid can also be suppressed.

In the liquid crystal display apparatus according to the first embodiment, by using a conductive paste for forming the connection member, the electrical connection between the first conductive film and the GND potential can be readily established. The conductive pad is disposed between the first conductive film and the GND potential. The electrical connections between the first conductive film and the conductive pad and between the conductive pad and the GND potential can also be readily established by using a conductive paste.

### Second Embodiment

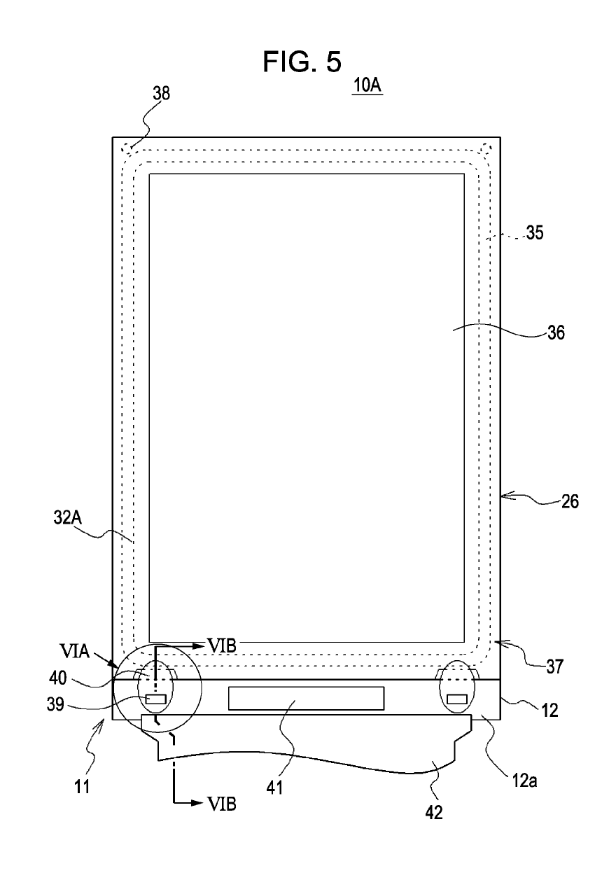

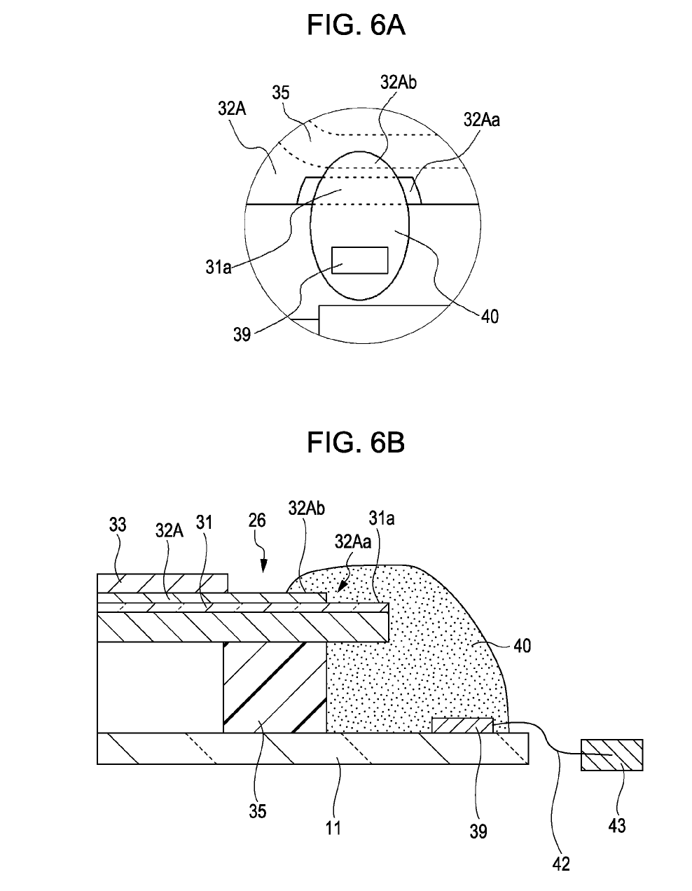

As for the liquid crystal display apparatus 10 according to the first embodiment, the case where the second conductive film is formed over the first conductive film except the portion where the first conductive film is connected to the conductive paste has been described. In contrast, as for a liquid crystal display apparatus 10A according to a second embodiment, a case where not only the first conductive film but also the second conductive film are connected to the conductive paste will be described with reference to FIGS. 5, 6A, and 6B. Since the difference of the liquid crystal display apparatus 10A according to the second embodiment from the liquid crystal display apparatus 10 according to the first embodiment is only a partial configuration of the second conductive film, the components that are common to the liquid crystal display apparatus 10 according to the first embodiment are denoted with like reference numerals and detailed descriptions of such components are abbreviated.

Referring to FIGS. 5, 6A, and 6B, a second conductive film 32A of the liquid crystal display apparatus 10A according to the second embodiment is formed so as to be partially in contact with a portion where the conductive paste 40 is to be applied. That is, unlike the liquid crystal display apparatus 10 according to the first embodiment, the second conductive film 32A has a connection portion 32Ab that is partially in contact with the conductive paste 40. The conductive paste 40 is applied so as to be in contact with the connection portion 32Ab. A cutout portion 32Aa is formed in the second conductive film 32A so that the first conductive film 31 is also in contact with the conductive paste 40. The conductive paste 40 is applied such that the conductive paste 40 is also in contact with the connection portion 31a of the first conductive film 31, the connection portion 31a being exposed through the cutout portion 32Aa of the second conductive film 32A.

By employing such a configuration, in the liquid crystal display apparatus according to the second embodiment, since the second conductive film is directly connected to the GND potential, even when the resistance between the stack of the first conductive film and the second conductive film becomes large, the resistance between the first conductive film and the second conductive film and the GND potential becomes small. Accordingly, static electricity and the like in the second conductive film can be sufficiently discharged to the GND potential.

In the first and second embodiments, the cases where the second conductive film is mainly composed of SnO₂ have been described. However, the present invention is not restricted to these cases. Advantages similar to those in the first and second embodiments can also be provided when, instead of SnO₂, a second conductive film mainly composed of In₂O₃, which has very high resistances to corrosion, acid, heat, and moisture is used.

It is preferred that the transparent conductive materials forming the first and second conductive films in the first and second embodiments have transmittances close to each other. By employing such a configuration, poor displaying caused by refraction of transmitted light between the conductive films can be suppressed. In the first and second embodiments, the cases where a conductive paste is used to form a connection member have been described. However, a connection member is not restricted to this, conductive materials may be appropriately selected to form a connection member.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A horizontal-electric-field liquid crystal display apparatus comprising:
a pair of substrates bonded together in peripheral portions of said pair of substrates by a sealing material;
a liquid crystal contained between the pair of substrates;
a display region formed in a portion surrounded by the sealing material, and a non-display region is formed outside the display region;
a first electrode and a second electrode formed on one of the pair of substrates;
an electric field generated between the first electrode and the second electrode drives the liquid crystal;
a first conductive film composed of a transparent conductive material formed on a surface of another of the pair of substrates, the surface being opposite to a surface in contact with the liquid crystal, the first conductive film connected to a ground potential through a connection member composed of a conductive material;
a second conductive film composed of a transparent conductive material formed on a surface of the first conductive film; and
a polarizing plate formed on a surface of the second conductive film.

2. The liquid crystal display apparatus according to claim 1, wherein the second conductive film is formed on the surface of the first conductive film except a portion where the first conductive film is in contact with the connection member.

3. The liquid crystal display apparatus according to claim 1, wherein the second conductive film is also connected to the ground potential through the connection member.

4. The liquid crystal display apparatus according to claim 1, wherein the second conductive film is formed at least in the display region.

5. The liquid crystal display apparatus according to claim 1, wherein the first conductive film is formed of ITO.

6. The liquid crystal display apparatus according to claim 1, wherein the second conductive film is at least mainly composed of SnO₂ or In₂O₃.

7. The liquid crystal display apparatus according to claim 1, wherein the transparent conductive materials forming the first conductive film and the second conductive film have transmittances close to each other.

8. The liquid crystal display apparatus according to claim 1, wherein the connection member is formed of a conductive paste.
